(19) United States
(12) Patent Application Publication
(10) Pub. No.: US 2004/0136652 A1
(43) Pub. Date: Jul. 15, 2004

(54) Optical waveguide bragg grating system

(76) Inventor: Christopher John Groves-Kirkby, Bugbrooke (GB)

Correspondence Address: LAHIVE & COCKFIELD, LLP., 28 STATE STREET, BOSTON, MA, 02109, US

(21) Appl. No.: 10/468,090

(22) PCT Filed: Feb. 13, 2002
(86) PCT No.: PCT/GB02/00657

(30) Foreign Application Priority Data
Feb. 13, 2001 (GB) 0103482.6

(51) Int. Cl. G02B 6/34

(52) U.S. Cl. 385/37

(57) ABSTRACT

An optical wavelength Bragg grating system has a length of optical waveguide (2) containing a set of Bragg gratings (10, 20, 30) at each of a number of locations along the fibre. Each location is assigned a unique digital code defining the wavelength set (λ₁, λ₄, λ₇; λ₁, λ₅, λ₉; λ₃, λ₆, λ₈) of the gratings at that location. The waveguide (2) is coupled to a wide-band optical source (5) and the combined response from all the grating locations is correlated (16) with each digital code to discriminate responses from the respective grating locations.

This invention relates to an optical waveguide Bragg grating system and particularly, although not exclusively to a system utilising optical fibre Bragg gratings as sensors.

Optical waveguide Bragg gratings are finding increasing application as sensors, particularly of mechanical strain and other parameters, for example temperature, which can be represented in terms of induced strain.

A plurality of Bragg gratings can usefully be cascaded along the length of a single waveguide such as an optical fibre. In sensor applications, this usefully provides the ability to sense a parameter at the location of each grating in the series. In such an arrangement each sensor in the series has a unique wavelength response and the sensors are addressed by means of a single wideband optical source, the bandwidth of which covers the wavelength response range of all the sensors in a series. Analysing the reflected response from all the sensors by means of a spectrum analyser enables the responses from individual sensors to be determined.

A cascaded Bragg grating system as described, has a significant limitation in the form of the inevitable compromise, which has to be made between the number of gratings in the series, their required dynamic range and the optical bandwidth available from a single optical source.

This invention seeks to provide an optical waveguide Bragg grating system in which the above-mentioned limitation is mitigated.

According to one aspect of the invention there is provided an optical waveguide Bragg grating system comprising a length of optical waveguide having a plurality of Bragg grating locations spaced apart along its length, each grating location containing a plurality of Bragg gratings formed thereat, each of the gratings at a respective location having a characteristic response wavelength different from the other gratings at that location, each location being assigned a unique digital code defining a unique set of response wavelengths of the gratings at that location, an optical source for providing an optical signal to the optical waveguide, the signal having a bandwidth which includes the response wavelength of each grating at each location ,a correlator for correlating in wavelength space combined optical responses from all locations with each code, whereby the responses from each grating location may be uniquely determined.

The optical waveguide is preferably an optical fibre, typically single mode optical fibre.

A signal amplitude threshold circuit may be coupled to an output of the correlator to increase discrimination of the responses from the respective grating locations.

The digital codes assigned to the grating locations may be Prime Codes.

The Bragg grating locations may be mechanical strain-sensing locations, a change in the wavelength response from a respective location being indicative of a change in mechanical strain induced in the optical waveguide at that location

According to a second aspect of the invention there is provided an optical Code Division Multiple Access (CDMA) data communications system comprising a length of optical fibre waveguide having a plurality of Bragg grating locations spaced apart along its length, each grating location containing a plurality of Bragg gratings formed thereat, each of the gratings at a respective location having a characteristic response wavelength different from the other gratings at that location, each location being assigned a unique digital code defining a unique set of response wavelengths of the gratings at that location and having a respective reflective tap, a plurality of optical sources coupled to the optical waveguide, each source having a unique respective wavelength corresponding to the characteristic response wavelength of a different respective one of the gratings at the plurality of Bragg grating locations, a data input for feeding data intended to be received at the reflective tap of a grating location to each optical source having a wavelength corresponding to the characteristic response wavelength of each grating at said grating location and a correlator coupled to each reflective tap for correlating in wavelength space optical signals received at a respective tap with each digital code, whereby data signals intended for that tap may be discriminated.

The optical waveguide is preferably an optical fibre, typically single mode optical fibre.

A signal amplitude threshold circuit may be coupled to an output of each correlator to increase discrimination of the responses from the respective grating locations.

The digital codes assigned to the grating locations may be Prime Codes.

An exemplary embodiment of the invention will now be described with reference to the drawings in which:

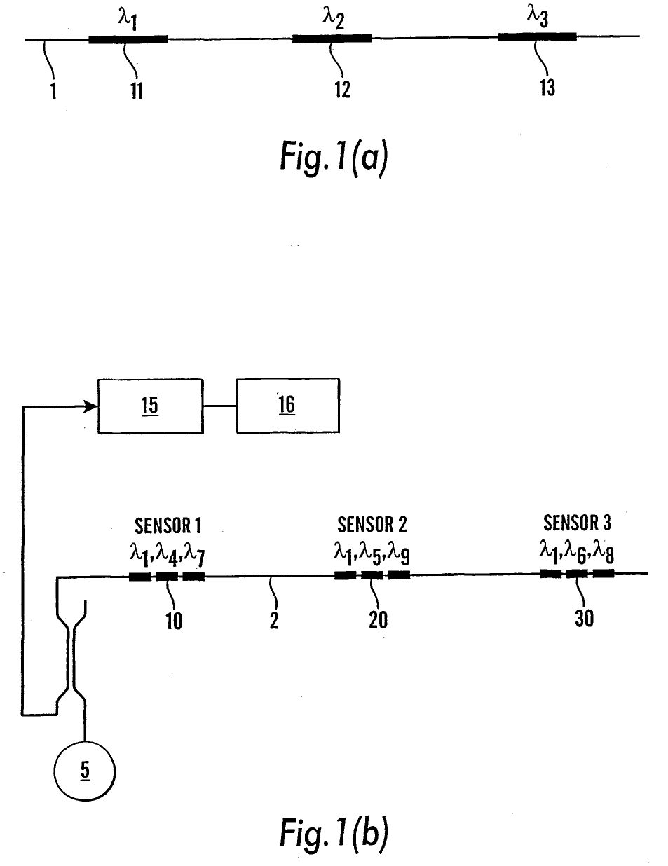

FIG. 1(a) shows a known Bragg grating system;

FIG. 1(b) shows a preferred embodiment of a Bragg grating system in accordance with a first aspect of the invention;

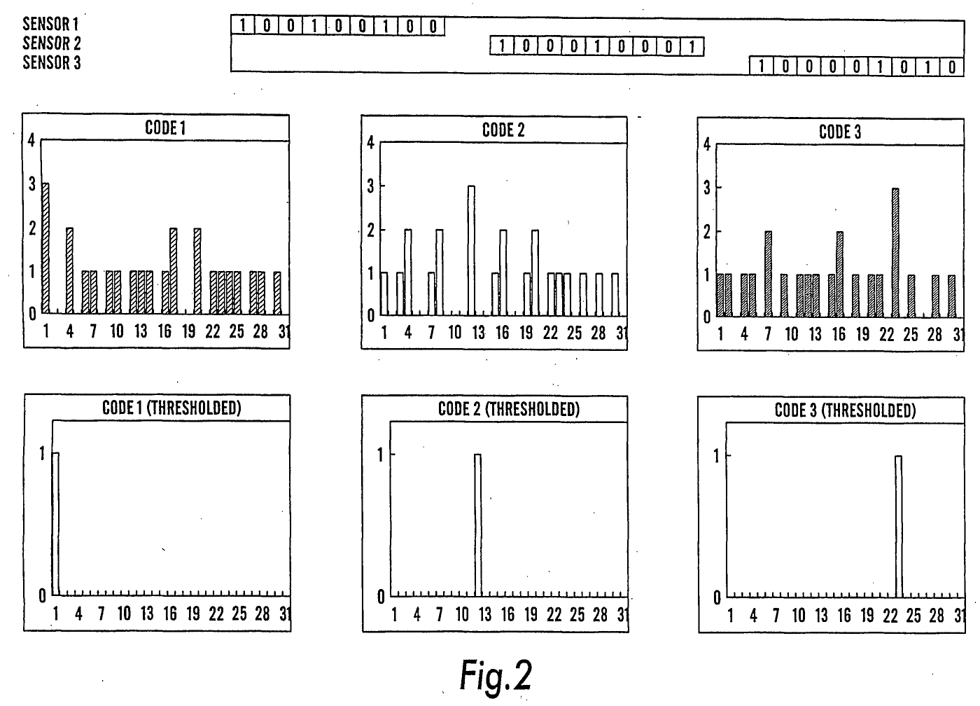

FIGS. 2, 3 and 4 illustrate results of correlation for three possible cases; and

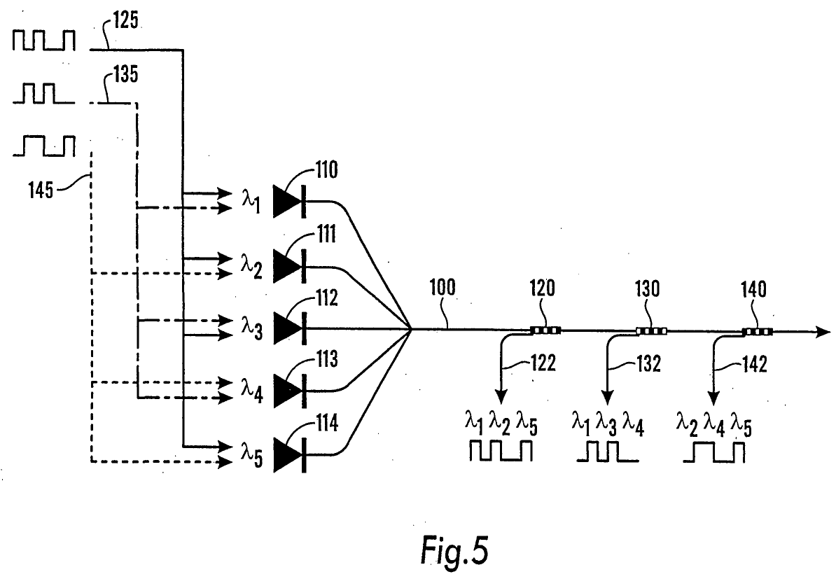

FIG. 5 shows. a preferred embodiment of an optical CDMA data communications system in accordance with a second aspect of the invention.

Referring now to FIG. 1(a), there is shown a known optical waveguide Bragg grating system in which a single mode optical fibre 1, has Bragg gratings 11, 12, and 13 of respective characteristic reflection wavelengths λ₁, λ₂, λ₃ formed at intervals along its length. In this example the gratings are provided as sensors for sensing, for example mechanical strain.

The gratings 11, 12 and 13 are typically addressed by means of a wide-band optical source coupled to the fibre 1 and reflected responses from the grating sensors are analysed by means of a spectrm analyser. A change in the spectral response of a grating sensor indicate a change in the sensed parameter, in this case mechanical strain.

A problem with this arrangement is the compromise, which must be made between the number of grating sensors, which may be cascaded in this way, their required dynamic range and the optical bandwidth available from a single source, to cover the range of characteristic reflection wavelengths of all the cascaded gratings. In a typical strain sensing application, it is possible to support eight cascaded Bragg grating sensors, each having a wavelength window 5 mn wide, equivalent to a strain-response range of 0-3000 μstrain, within the typical 40 nm spectral range of state-of-the-art semiconductor diode sources.

In seeking to mitigate this problem, the present invention draws on techniques from the field of Code Division Multiple Access, (CDMA) communications to provide resolution of the responses from optical waveguide Bragg gratings.

In a typical CDMA system, each bit is encoded into a waveform s(t) that corresponds to a code sequence of N chips representing the destination address of that bit. Each receiver correlates its own address f(t) with the received signal s(t). The received output r(t) is:

r(t)=∫_{∞}^{∞}s(z)·f(z−t)·dz (1)

If the signal has arrived at the correct destination, then s(t)=f(t) and Equation (1) represents an auto-correlation function. If the signal has arrived at an incorrect destination, then s(t) f(t) and (1) represents a cross-correlation function. At each receiver, to maximise the discrimination between the correct (destination) signal and interference (all other signals), it is necessary to maximise the auto-correlation function and to minimise the cross-correlation function. This is accomplished by selecting a set of orthogonal code sequences. Optimum discrimination occurs for conditions under which the auto-correlation function is a maximum and the cross-correlation function is simultaneously a minimum. The size of the code applied to each transmitted bit depends on the number of receivers in the system. In a binary signalling scheme, this has a minimum size of 2^{N-1}, where N is the number of receivers involved, although optimum code design strategies may demand significantly longer codes.

In the present invention these principles are applied in a first aspect of the invention to discriminating responses from a set of Bragg grating locations spaced along a length of optical waveguide and in a second aspect to provide an optical CDMA data system in which data signals intended for respective ones of a number of locations may be discriminated by means of Bragg gratings provided at those locations.

Referring to FIG. 1(b), there is shown a Bragg grating sensor system comprising an optical waveguide in the form of a single mode optical fibre 2 provided with Bragg grating locations 10, 20, 30 at spaced intervals along its length. A wideband optical source 5 is coupled to feed the optical fibre 2 and signals reflected from each Bragg grating location 10, 20, 30 are fed to a spectrum analyser 15 and then to a correlator circuit 16.

Each Bragg grating location incorporates three gratings each having its own respective characteristic wavelength response, the set of three wavelengths at each grating location being unique to that location and hence different from the wavelength response set of any other grating location.

Each grating location 10, 20, 30 is assigned a digital code which defines in wavelength space the characteristic wavelength response of the three gratings at the respective location. Suitable code sequences are Prime Codes. These were initially developed as codes applicable to optical systems, giving better correlation properties in intensity-summation systems (i.e. in which the detected signal is always zero or positive) than the previous generation of codes (exemplified by Gold-sequences), which are more applicable to amplitude-detection. The following description is made with reference to Prime Codes, but the invention is not limited to such codes and any other suitable code sequence may be used.

For the system of FIG. 1(b), having three sensing sites, each with three gratings, the relevant Prime Codes are;

| User | Code Sequence | | |
|---|---|---|---|
| 1 | 100 | 100 | 100 |
| 2 | 100 | 010 | 001 |
| 3 | 100 | 001 | 010 |

In this case Users 1, 2 and 3 represent the Bragg grating locations 10, 20, 30 and the code sequences represent the wavelengths of the characteristic wavelength responses of the three Bragg gratings at each location Thus in a wavelength space covering nine different characteristic wavelengths of the code sequence, the gratings for user 1 at location 10 are assigned wavelengths λ₁, λ₄ and λ₇, those at grating location 20 wavelengths λ₁, λ₅ and λ₉ and those at location 30 wavelengths λ₁, λ₆ and λ₈.

As described, a multiplicity of sensors share a common wavelength space and the potential dynamic range, in wavelength terms, can therefore be much larger, since it is not necessary to prevent the dynamic wavelength excursions of one grating from encroaching on the spectral space allocated to its neighbours. In wavelength-space, therefore, the reflected response of a particular sensor comprises a number of delta-functions, forming a pattern unique to that sensor.

In order to discriminate the responses from the individual Bragg grating sensor locations, a spectral analysis is made of the sum of all grating sensor responses, taking no account of the positional origin of the signals received by the detection system consisting of the spectrum analyser 15 and the correlator 16. In the present example in which the Bragg gratings at the three locations are functioning as strain sensors, as an individual sensing location experiences strain (or responds to an influence inducing strain) its characteristic coded response pattern shifts across the spectrum, modifying the integrated detected spectrum.

By performing, in correlator 16, a correlation in wavelength-space of the integrated detected spectral pattern against the specific sensor code, it is possible to assign the sensor response a position, which directly represents the induced shift in the wavelength pattern associated with the specific sensor location. With suitable choice of code patterns, the cross-correlation of the detected pattern associated with any particular sensor against the codes of the remaining sensors in the set can be minimised, providing an unambiguous interrogation of any individual sensors in the set.

Referring now to FIGS. 2, 3 and 4 there are shown the output of the correlator 16 for three cases. The first line of each Figure shows the raw results of autocorrelation, while the second row shows the same results after subjecting to thresholding.

In FIG. 2, the nine-bit codes for each of the three sensor locations occupy non-overlapping positions in a 32-bin wavelength space. In this case all sensor locations are completely resolved at positions 1, 12 and 23.

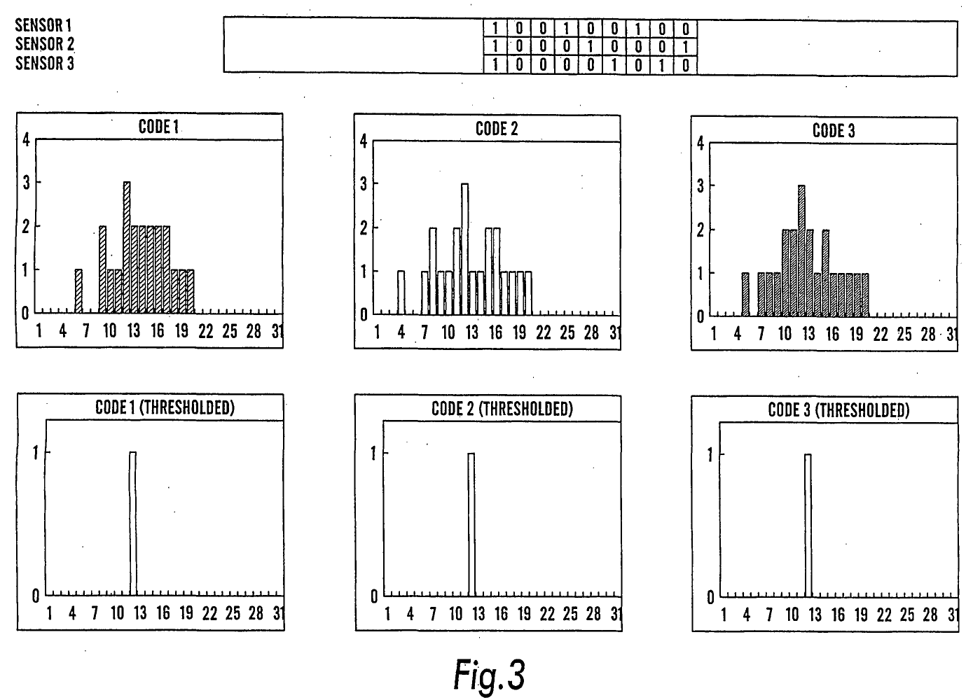

In FIG. 3, all three sensor locations are completely coincident in wavelength space, but as can be seen, the auto correlation with the respective codes discriminates each sensor response at position 12.

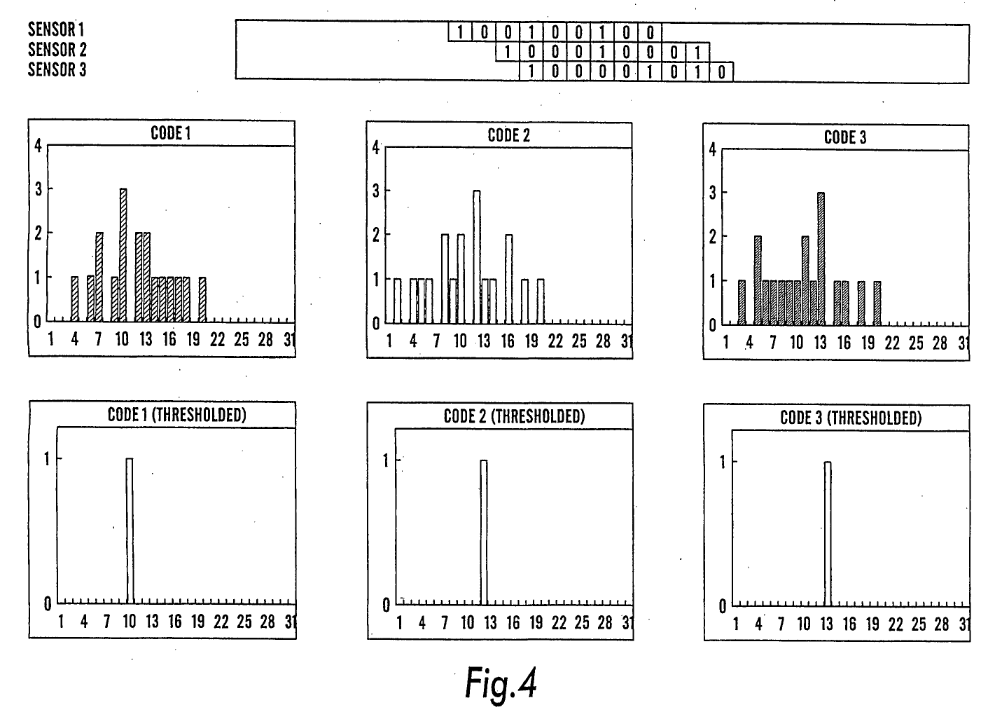

Similarly in FIG. 4, where sensor codes overlap in wavelength space, sensor outputs at positions 10, 12 and 13 are discriminated.

As can also be seen by thresholding the correlator output at signal magnitude slightly in excess of 2 on the vertical axis of each figure, the discrimination against unwanted signals is considerable enhanced

The above example has been described with reference to a nine bit code suitable for three sensor locations. The size of the code can be increased with a corresponding increase in the number of grating/sensing locations which may be supported and enhanced discrimination between auto-correlation and cross-correlation functions.

The following is an example of the Prime codes for a five user/location system;

| User | Code Sequence |
|---|---|
| 1 | 10000 10000 10000 10000 10000 |
| 2 | 10000 01000 00100 00010 00001 |
| 3 | 10000 00100 00001 01000 00010 |
| 4 | 10000 00010 01000 00001 00100 |
| 5 | 10000 00001 00010 00100 01000 |

The multiple Bragg gratings at each of the grating locations may be formed adjacent to each other. The Bragg gratings of at least one grating location may be superimposed one upon another and preferably such multiple gratings are so superimposed at each of the grating locations. Multiple gratings may be formed by known techniques for forming Bragg gratings in optical fibres, such as, holographic exposure, phase mask exposure or direct writing into the fibre by optical beam.

In a second aspect, the invention may usefully be applied to provide an optical data communications system. One exemplary embodiment is illustrated in FIG. 5. In FIG. 5, an optical waveguide in the form of a single mode optical fibre 100 has coupled thereto five optical sources, typically laser diode sources, 110, 111, 112, 113 and 114, of respective wavelengths λ₁, λ₂, λ₃, λ₄, and λ₅.

At each of a plurality of locations, 120, 130 and 140 is provided a set of three Bragg gratings, those at location 120 having characteristic response wavelengths λ₁, λ₂, and λ₅, those at location 130 wavelengths λ₁, λ₃ and λ₄ and finally those at location 130 having wavelengths λ₂, λ₄, and λ₅. Also at each grating location the fibre has a respective reflective tap 122, 132 and 142.

The optical sources 110 through 114 have data inputs 125, 135 and 145, for the supply of data intended to be received at the grating locations 120, 130 and 140 by way of the reflective taps 122, 132 and 142. The data input 125, which carries data intended for reception by a user assigned to the tap 122, is coupled to drive the optical sources 110, 111 and 114, having wavelengths corresponding to the three wavelength responses of the gratings at the location 120. Similarly the data input 135 is coupled to the optical sources 110, 112 and 113 and the data input 145 to the sources 111, 113 and 114.

As with the embodiment described with respect to FIG. 1(b) in conjunction with FIGS. 2 to 4, a spectrum analyzer and correlator is coupled to each tap 122, 132, 142 and an auto correlation function is performed in wavelength space between the signals received at each of the taps and the digital codes assigned to the taps, in the manner described above. In this way data intended to be transmitted to each of the users associated with each reflective tap along the optical fibre 100, may be discriminated.

The invention has been described by way of example and modifications may be made without departing from the scope of the invention. In particular, the invention is not restricted to the use of optical fibre waveguides and any other suitable optical waveguide may be used, such as those formed using lithium niobate, III-V semiconductor and silica technologies. More than three gratings may also be employed at each location. The invention is also not restricted to the use of Prime Codes and any other suitable code structure may be employed. All that is required is that the digital code sequence chosen is suitable to support the number of gratings per location and the number of locations.

1. An optical waveguide Bragg grating system comprising a length of optical waveguide having a plurality of Bragg grating locations spaced apart along its length, each grating location containing a plurality of Bragg gratings formed thereat, each of the gratings at a respective location having a characteristic response wavelength different from the other gratings at that location, each location being assigned a unique digital code representative of a unique set of response wavelengths of the gratings at that location, an optical source for providing an optical signal to the optical waveguide, the signal having a bandwidth which includes the response wavelength of each grating at each location, a correlator for correlating in wavelength space combined optical responses from all locations with. each code, whereby. the responses from each grating location may be uniquely determined.

2. The grating system of claim 1 in which the Bragg gratings of at least one grating location are superimposed.

3. The grating system of claim 1 or 2 in which a signal amplitude threshold circuit is coupled to an output of the correlator to increase discrimination of the responses from the respective grating locations.

4. The grating system of any preceding claim in which the digital codes assigned to the grating locations are Prime Codes.

5. The grating system of any preceding claim in which the Bragg grating locations are mechanical strain-sensing locations, a change in the wavelength response from a respective location being indicative of a change in mechanical strain induced in the optical waveguide at that location.

6. An optical CDMA data communications system comprising a length of optical waveguide having a plurality of Bragg grating locations spaced apart along its length, each grating location containing a plurality of Bragg gratings formed thereat, each of the gratings at a respective location having a characteristic response wavelength different from the other gratings at that location, each location being assigned a unique digital code representative of a unique set of response wavelengths of the gratings at that location and having a respective reflective tap, a plurality of optical sources coupled to the. optical waveguide, each source having a unique respective wavelength corresponding to the characteristic response wavelength of a different respective one of the gratings at the plurality of Bragg grating locations, a data input for feeding data intended to be received at the reflective tap of a grating location to each optical source having a wavelength corresponding to the characteristic response wavelength of each grating at said grating location and a correlator coupled to each reflective tap for correlating in wavelength space optical signals received at a respective tap with each digital code, whereby data signals intended for that tap may be discriminated

7. The system of claim 6 in which the Bragg gratings of at least one grating location are superimposed

8. The system of claim 6 or 7 in which a signal amplitude threshold circuit is coupled to an output of each correlator to increase discrimination of the responses from the respective grating locations.

9. The system of claims 6, 7 or 8 in which the digital codes assigned to the grating locations are Prime Codes.

10. The system of any preceding claim in which the optical waveguide is a length of optical fibre.

11. The system of claim 10 in which the optical fibre is single mode optical fibre.
